(19) United States
(12) Patent Application Publication
(10) Pub. No.: US 2021/0223618 A1
(43) Pub. Date: Jul. 22, 2021

(54) FILTER SUBSTRATE AND LIQUID CRYSTAL DISPLAY PANEL

(71) Applicant: WUHAN CHINA STAR OPTOELECTRONICS TECHNOLOGY CO., LTD., Wuhan, Hubei (CN)

(72) Inventor: Fancheng LIU, Wuhan, Hubei (CN)

(21) Appl. No.: 16/308,942

(22) PCT Filed: Nov. 22, 2018
(86) PCT No.: PCT/CN2018/117042

§ 371 Date: Dec. 11, 2018

(30) Foreign Application Priority Data
Aug. 28, 2018 (CN) 201810990109.2

(51) Int. Cl. G02F 1/1335; G02F 1/13357; G02F 1/1368

(52) U.S. Cl. CPC G02F 1/133519; G02F 1/133617; G02F 2202/36; G02F 1/133512; G02F 1/1368; G02F 1/133528

(57) ABSTRACT

A color filter substrate arranged in an LCD panel is provided. The color filter substrate includes a transparent substrate, a plurality of QDs arranged on the transparent substrate, a band-pass filter film arranged on the transparent substrate, and a polarizing layer, arranged on the band-pass filter film. The QDs includes a blue QD, a green QD, and a red QD. Owing to the characteristics of band-pass filter films, the blue light can pass by and the green light and the red light can be reflected. So the exciting light can be propagated in an effective direction according to design requirements so as to avoid the technical problem of mutual crosstalk, thereby improving the light efficiency of the structure of the color filter substrate and improving the display quality of the LCD panel.

### BACKGROUND

### 1. Field of the Disclosure

The present disclosure relates to the field of display, and more particularly, to a color filter substrate using quantum dots (QDs) as a filter unit and a liquid crystal display device with the filter unit.

### 2.Description of the Related Art

On the progressive development of liquid crystal display (LCD) technology, a variety of LCD panels have been well developed. An LCD panel with high gamut and low power consumption satisfies the need for a portable mobile device. However, an LCD panel with color gamut generally has disadvantages of low transmittance and high power consumption. In order to solve this problem, QDs are taken into consideration by the industry. QDs have advantages of expanded gamut, high color purity, and low power consumption so QDs serve as filter units. Therefore, QDs as filter units become one of the components of an LCD panel.

However, a problem that QDs are used as filter units is that red QDs and green QDs are excited and emit light once a blue light-emitting diode (LED) is used as backlight source of the LCD panel, which causes polarization of the QDs as filter units to disappear. Moreover, the direction of light propagation caused by the excitation is not fixed so that some of the light after excitation will reenter the liquid crystal layer, and the rest will propagate to the left and right, causing mutual crosstalk, which ultimately affects the display quality.

Therefore, a solution to the problem of the related art must be proposed to improve the performance of QDs as filter units for an LCD panel.

### SUMMARY

In view of the above-mentioned problem of the related art, the present disclosure proposes a color filter substrate adopting quantum dots (QDs) as filter units and a liquid crystal display (LCD) with the color filter substrate. The characteristics of the red light and the green light reflected by a band-pass filter film are applied to make the exciting light propagate in an effective direction according to design requirements to avoid the technical problems of mutual crosstalk, thereby improving the light efficiency of the structure of the color filter substrate and improving the display quality of the LCD panel.

In a first aspect of the present disclosure, a color filter substrate arranged in a liquid crystal display (LCD) panel is provided. The color filter substrate includes a transparent substrate, a plurality of quantum dots (QDs) arranged on the transparent substrate, a band-pass filter film arranged on the transparent substrate, and a polarizing layer, arranged on the band-pass filter film. The plurality of QDs includes a blue QD, a green QD, and a red QD. The band-pass filter film covers the plurality of QDs and is configured to allow a blue light pass by, and reflect a green light and a red light.

According to the present disclosure, the color filter substrate further comprises an overcoat The overcoat is arranged between the polarizing layer and the band-pass filter film and configured to isolate the polarizing layer from the band-pass filter film.

According to the present disclosure, material of the overcoat is epoxy or acrylic.

According to the present disclosure, the color filter substrate further comprises a black matrix layer. The black matrix layer is arranged on the transparent substrate and among the plurality of QDs.

In a second aspect of the present disclosure, a color filter substrate arranged in a liquid crystal display (LCD) panel is provided. The color filter substrate includes a transparent substrate, a plurality of quantum dots (QDs) arranged on the transparent substrate, a first overcoat arranged on the transparent substrate and covering the plurality of QDs, a band-pass filter film, arranged on the first overcoat and the plurality of QDs, and a polarizing layer, arranged on the band-pass filter film. The QDs include a blue QD, a green QD, and a red QD. The band-pass filter film is configured to allow a blue light pass by, and reflecting a green light and a red light.

According to the present disclosure, the color filter substrate further includes an isolating layer. The isolating layer is arranged between the polarizing layer and the band-pass filter film and configured to isolate the polarizing layer from the band-pass filter film.

According to the present disclosure, a second overcoat is configured to isolate the polarizing layer from the band-pass filter film.

According to the present disclosure, material of the first overcoat and the second overcoat is epoxy or acrylic.

According to the present disclosure, the color filter substrate further comprises a black matrix layer. The black matrix layer is arranged on the transparent substrate and among the plurality of QDs.

In a third aspect of the present disclosure, a liquid crystal display (LCD) panel includes a lower polarizer configured to polarize light, an array substrate, a liquid crystal layer and a color filter substrate. The array substrate includes a plurality of thin film transistors (TFTs) which are arranged on the array substrate. The color filter substrate includes a transparent substrate, a plurality of quantum dots (QDs) arranged on the transparent substrate, a first overcoat arranged on the transparent substrate and covering the plurality of QDs, a band-pass filter film, arranged on the first overcoat and the plurality of QDs, and a polarizing layer, arranged on the band-pass filter film. The QDs include a blue QD, a green QD, and a red QD. The band-pass filter film is configured to allow a blue light pass by, and reflecting a green light and a red light.

According to the present disclosure, the color filter substrate further includes an isolating layer. The isolating layer is arranged between the polarizing layer and the band-pass filter film and configured to isolate the polarizing layer from the band-pass filter film.

According to the present disclosure, a second overcoat is configured to isolate the polarizing layer from the band-pass filter film.

According to the present disclosure, material of the first overcoat and the second overcoat is epoxy or acrylic.

According to the present disclosure, the color filter substrate further comprises a black matrix layer. The black matrix layer is arranged on the transparent substrate and among the plurality of QDs.

Compared with the related art, the present disclosure proposes a color filter substrate with QDs as filter units and an LCD with the color filter substrate, and the band-pass filter film is arranged on the plurality of the QDs. Owing to the characteristics of band-pass filter films, the blue light can pass by and the green light and the red light can be reflected. So the exciting light can be propagated in an effective direction according to design requirements so as to avoid the technical problem of mutual crosstalk, thereby improving the light efficiency of the structure of the color filter substrate and improving the display quality of the LCD panel.

These and other features, aspects and advantages of the present disclosure will become understood with reference to the following description, appended claims and accompanying figures.

### BRIEF DESCRIPTION OF THE DRAWINGS

FIG. 1 illustrates a schematic diagram of a liquid crystal display according to an embodiment of the present disclosure.

FIG. 2 illustrates a schematic diagram of a liquid crystal display (LCD) panel according to an embodiment of the present disclosure.

FIG. 3 illustrates a schematic diagram of an array substrate according to an embodiment of the present disclosure.

FIG. 4 illustrates a schematic diagram of a color filter substrate according to the first embodiment of the present disclosure.

FIG. 5 illustrates a schematic diagram of a color filter substrate according to the second embodiment of the present disclosure.

FIG. 6 illustrates a schematic diagram of a color filter substrate according to the third embodiment of the present disclosure.

FIG. 7 illustrates a schematic diagram of a color filter substrate according to a fourth embodiment of the present disclosure.

### DETAILED DESCRIPTION OF THE EMBODIMENTS

In the disclosure, it is should be understood that spatially relative terms, such as “center”, “longitudinal”, “lateral”, “length”, “width”, “above”, “below”, “front”, “back”, “left”, “right”, “horizontal”, “vertical”, “top”, “bottom”, “inner”, “outer”, “clockwise”, “counterclockwise”, “axial”, “radial”, “circumferential”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The spatially relative terms are not limited to specific orientations depicted in the figures.

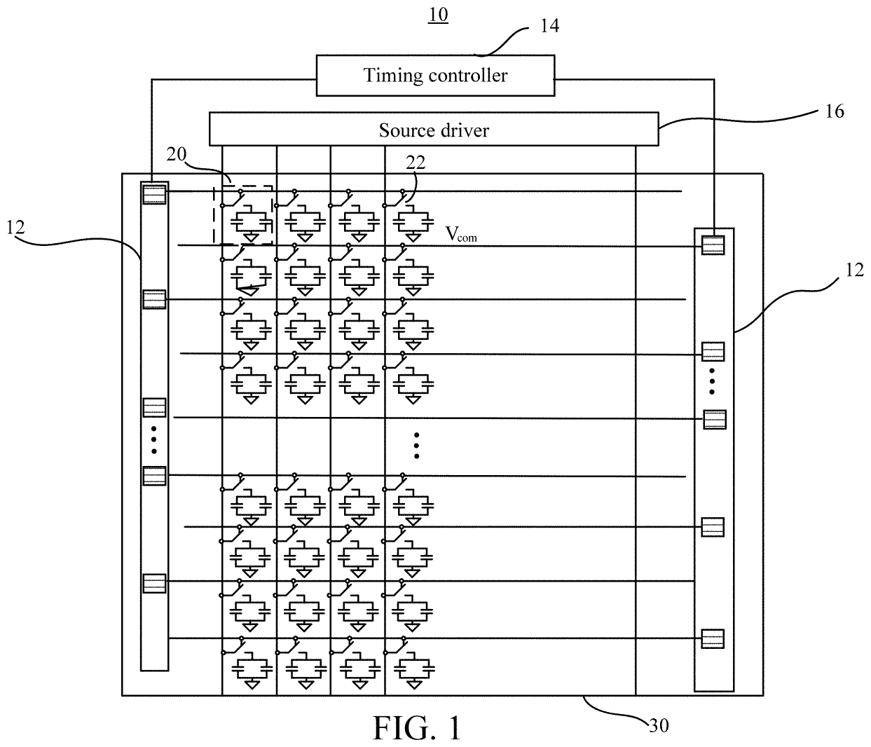

Please refer FIG. 1 illustrating a schematic diagram of a liquid crystal display (LCD) 10 according to an embodiment of the present disclosure. The LCD 10 includes a gate driver 12, a timing controller 14, a source driver 16, and an LCD panel 30. A plurality of pixels are arranged in a matrix on the LCD panel 30. Each of the plurality of pixels includes three pixel units 20 respectively representing three primary colors of red (R), green (G), and blue (B). The gate driver 12 outputs a scanning signal every fixed interval such that transistors 22 in each row are sequentially turned on. Meanwhile, the source driver 16 outputs a data signal correspondingly to an entire column of pixel units 20 to charge the pixel units 20 to respective required voltages. The pixel units 20 is propelled to display a wide diversity of grayscale according to the voltage difference between voltage imposed on the data signal and common voltage Vcom. When the transistors 22 in the same row are charged, the gate driver 12 turns off the scanning signal in the row. Afterwards, the gate driver 12 outputs a scanning signal to turn on the transistor 22 in the next row. Next, the source driver 16 charges and discharges the pixel unit 20 in the next row. These acts are continued until all the pixel units 20 are fully charged. In the end, charging starts from the first row again. Liquid crystal molecules corresponding to the pixel units 20 are twisted based on the voltage difference between the voltage imposed on the data signal and the common voltage Vcom. A wide diversity of grayscale is displayed accordingly.

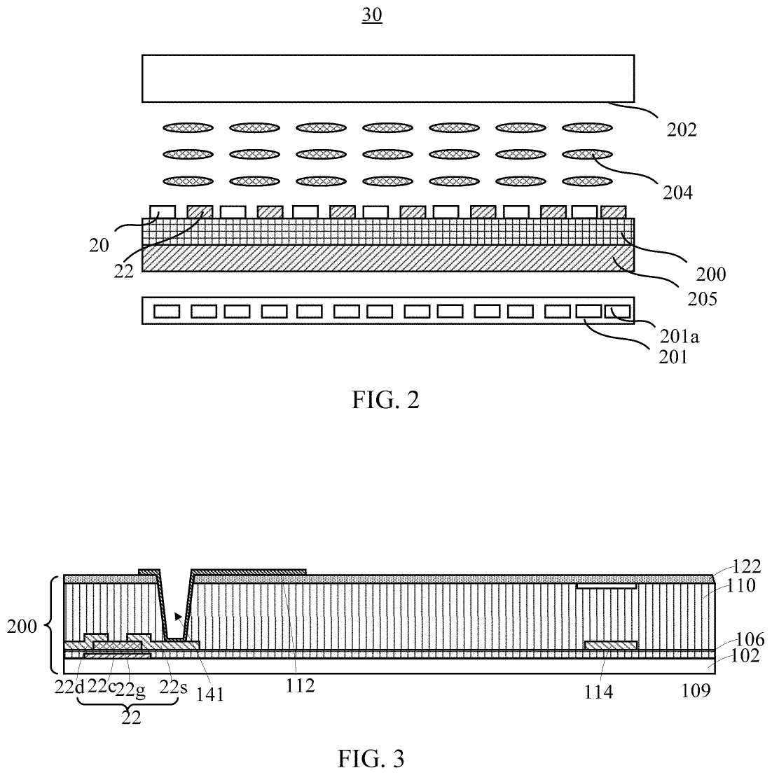

Please refer FIG. 2 illustrating a schematic diagram of a liquid crystal display (LCD) panel 30 according to an embodiment of the present disclosure. The LCD panel 30 includes an array substrate 200, a backlight module 201, a color filter substrate 202, a liquid crystal layer 204, and a lower polarizer 205. The backlight module 201 includes a plurality of blue light emitting diodes (LEDs) 201a. Each of the plurality of blue LEDs is configured to emit the blue light. The lower polarizer 205 polarizes the light emitted by the backlight module 201. A plurality of pixel units 20 and a plurality of thin film transistors (TFTs) 22 are arranged on the array substrate 200.

Please refer FIG. 3 illustrating a schematic diagram of an array substrate 200 according to an embodiment of the present disclosure. The array substrate 200 includes a glass substrate 102, a gate insulating layer 106, an isolating layer 110, a passivation layer 122, and a pixel electrode layer 112. A gate 22g of a thin film transistor (TFT) 22 is arranged on the substrate 102. The gate insulating layer 106 is arranged on the glass substrate 102. A semiconductor layer formed of the amorphous silicon layer is arranged on the gate insulating layer 106 and serves as a semiconductor layer 22c of the TFT 22. A source 22s and a drain 22d of the thin film transistor 22 and a data line 114 are arranged on the gate insulating layer 106. The data line 114 is configured to transfer a data signal sent by the source driver 16 to the TFT 22. A hole 141 is arranged on the isolating layer 110 and penetrates the isolating layer 110. The hole 141 is aligned with the source 22s or the drain 22d. The passivation layer 122 covers the isolating layer 110. The pixel electrode layer 112 is arranged on the passivation layer 122. The pixel electrode layer 112 is connected to the source 22s or the drain 22d through the hole 141.

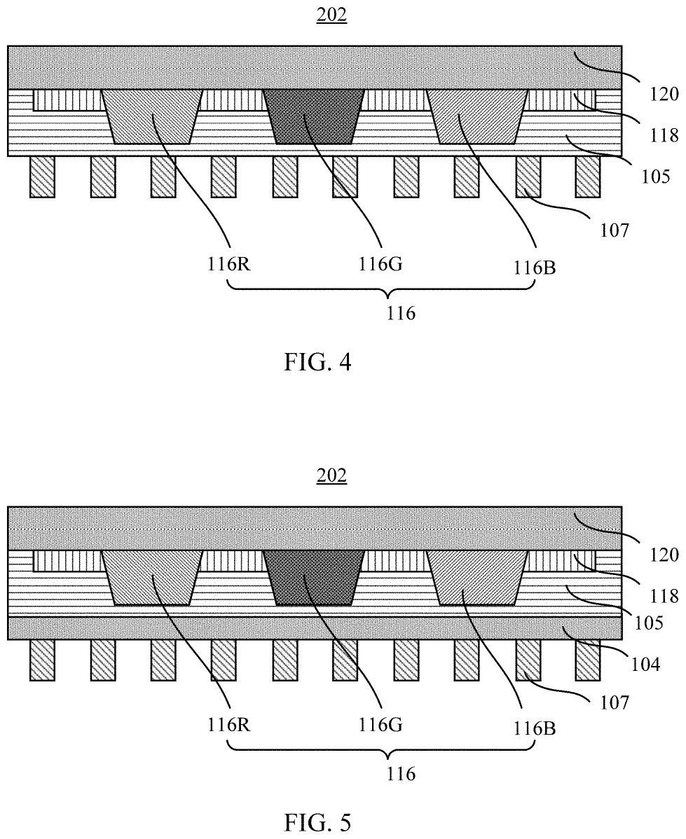

Please refer FIG. 4 illustrating a schematic diagram of a color filter substrate 202 according to the first embodiment of the present disclosure. The color filter substrate 202 includes a plurality of quantum dots (QDs) 116, a black matrix layer 118, a band-pass filter film 105, a polarizing layer 107, and a transparent substrate 120. The transparent substrate 120 may be a glass substrate. The plurality of QDs 116 includes a blue QD 116B, a green QD 116G, and a red QD 116R. The blue QD 116B, the green QD 116G, and the red QD 116R are configured to filter the blue light, the green light, and the red light, respectively. The black matrix layer 118 is arranged on the transparent substrate 120 and among the plurality of QDs 116 and configured to block the leaked light. The band-pass filter film 105 introduced in the present disclosure shows characteristics that the transmittance of the blue light is greater than 98% and that the reflectance of the red light and the green light is greater than 95%. So the blue light can block the red light and the green light successfully. The polarizing layer 107 is arranged on the band-pass filter film 105 and configured to polarize the incident light. The band-pass filter film 105 has characteristics of letting the blue light to pass by and reflecting the green light and the red light, so the red light generated by the blue QD 116R and the green light generated by the green QD 116G are excited by the blue light emitted by a light emitting diode (LED) 201a and reflected, which in turn limits the direction of propagation of the red light and the green light. Specifically, in addition to the light in an emergent direction above, the band-pass filter film 105 blocks the red light and the green light in all other directions from reentering the liquid crystal layer 204, thereby avoiding mutual crosstalk. In addition, since the reflectance of the red light/green light of the band-pass filter film 105 is greater than 95%, the light entering the liquid crystal layer 204 the second time can be reflected as the effective light which is emitted outward above, thereby improving the display quality (such as improving the cross color, reducing color dispersion, and improving contrast).

Please refer FIG. 5 illustrating a schematic diagram of a color filter substrate 202 according to the second embodiment of the present disclosure. The color filter substrate 202 includes a plurality of quantum dots (QDs) 116, a black matrix layer 118, an overcoat 104, a band-pass filter film 105, a polarizing layer 107, and a transparent substrate 120. The transparent substrate 120 may be a glass substrate. The plurality of QDs 116 includes a blue QD 116B, a green QD 116G, and a red QD 116R. The blue QD 116B, the green QD 116G, and the red QD 116R are configured to filter the blue light, the green light, and the red light, respectively. The black matrix layer 118 is arranged on the transparent substrate 120 and among the plurality of QDs 116 to block the leaked light. The overcoat 104 is arranged between the polarizing layer 107 and the band-pass filter film 105 and configured to isolate the polarizing layer 107 from the band-pass filter film 105. The material of the overcoat 104 may be epoxy or acrylic. The overcoat 104 is primarily configured to protect the plurality of QDs 116 and improve the smoothness of the surface. Also, the overcoat 104 is configured to isolate the band-pass filter film 105 from the polarizing layer 107, isolate a liquid crystal layer 204, and prevent contamination.

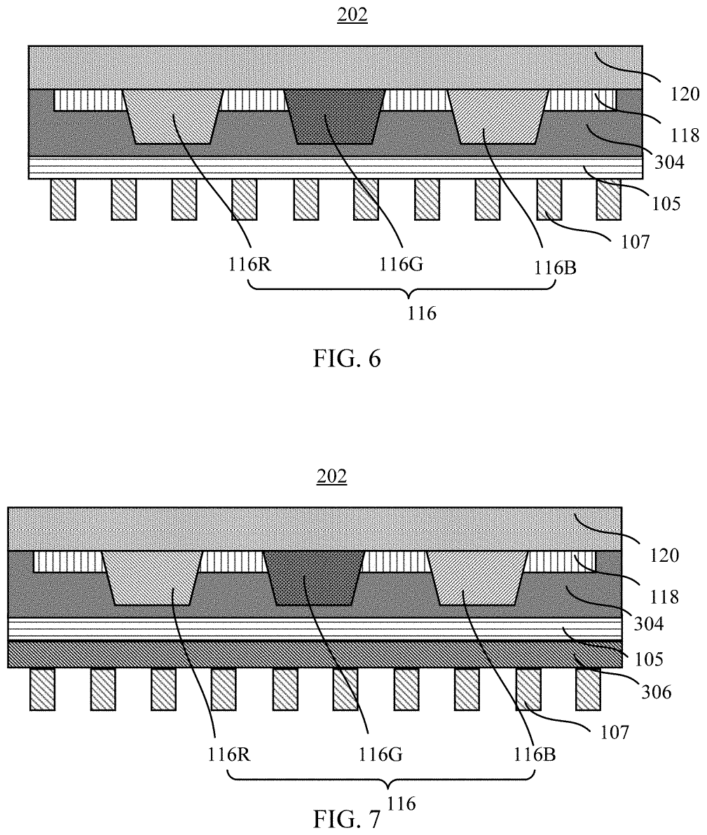

Please refer FIG. 6 illustrating a schematic diagram of a color filter substrate 202 according to the third embodiment of the present disclosure. The color filter substrate 202 includes a plurality of quantum dots (QDs) 116, a black matrix layer 118, a first overcoat 304, a band-pass filter film 105, a polarizing layer 107, and a transparent substrate 120. The transparent substrate 120 may be a glass substrate. The plurality of QDs 116 includes a blue QD 116B, a green QD 116G, and a red QD 116R. The blue QD 116B, the green QD 116G, and the red QD 116R are configured to filter the blue light, the green light, and the red light, respectively. The black matrix layer 118 is arranged on the transparent substrate 120 and among the plurality of QDs 116 and configured to block the leaked light. The first overcoat 304 is arranged on the transparent substrate 120 and covers the plurality of QDs 116 and configured to isolate the plurality of QDs 116 from the band-pass filter film 105. The material of the first overcoat 304 may be epoxy or acrylic. The first overcoat 304 is primarily configured to protect the plurality of QDs 116 and improve the smoothness of the surface. Also, the first overcoat 304 is configured to isolate a liquid crystal layer 204 and prevent contamination. The band-pass filter film 105 is arranged on the first overcoat 304 and the plurality of QDs 116. The band-pass filter film 105 introduced in the present disclosure shows characteristics that the transmittance of the blue light is greater than 98% and that the reflectance of the red light and the green light is greater than 95%. So the blue light can block the red light and the green light successfully. The polarizing layer 107 is arranged on the band-pass filter film 105 and configured to polarize the incident light. The band-pass filter film 105 has characteristics of letting the blue light to pass by and reflecting the green light and the red light, so the red light generated by the blue QD 116R and the green light generated by the green QD 116G are excited by the blue light emitted by a light emitting diode (LED) 201a and reflected, which in turn limits the direction of propagation of the red light and the green light. Specifically, in addition to the light in an emergent direction above, the band-pass filter film 105 blocks the red light and the green light in all other directions from reentering the liquid crystal layer 204, thereby avoiding mutual crosstalk. In addition, since the reflectance of the red light/green light of the band-pass filter film 105 is greater than 95%, the light entering the liquid crystal layer 204 the second time can be reflected as the effective light which is emitted outward above, thereby improving the display quality (such as improving the cross color, reducing color dispersion, and improving contrast).

Please refer FIG. 7 illustrating a schematic diagram of a color filter substrate 202 according to a fourth embodiment of the present disclosure. The color filter substrate 202 includes a plurality of quantum dots (QDs) 116, a black matrix layer 118, a first overcoat 304, a band-pass filter film 105, a second overcoat 306, a polarizing layer 107, and a transparent substrate 120. The transparent substrate 120 may be a glass substrate. Each of the plurality of QDs 116 includes a blue QD 116B, a green QD 116G, and a red QD 116R. The blue QD 116B, the green QD 116G, and the red QD 116R are configured to filter the blue light, the green light, and the red light, respectively. The black matrix layer 118 is arranged on the transparent substrate 120 and among the plurality of QDs 116 and configured to block the leaked light. The first overcoat 304 is arranged on the transparent substrate 120 and covers the plurality of QDs 116. The first overcoat 304 is configured to isolate the plurality of quantum dots 116 from the band-pass filter film 105. The material of the first overcoat 304 and the second overcoat 306 may be epoxy or acrylic. The first overcoat 304 is mainly configured to protect the plurality of QDs 116 and improve smoothness of the surface. The second overcoat 306 is configured to isolate the liquid crystal layer 204 and prevent contamination. The band-pass filter film 105 is arranged on the first overcoat 304 and the plurality of QDs 116.

Compared with the related art, the present disclosure proposes a color filter substrate with QDs as filter units and an LCD with the color filter substrate, and the band-pass filter film is arranged on the plurality of the QDs. Owing to the characteristics of band-pass filter films, the blue light can pass by and the green light and the red light can be reflected. So the exciting light can be propagated in an effective direction according to design requirements so as to avoid the technical problem of mutual crosstalk, thereby improving the light efficiency of the structure of the color filter substrate and improving the display quality of the LCD panel.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A color filter substrate, arranged in a liquid crystal display (LCD) panel, comprising:
a transparent substrate;
a plurality of quantum dots (QDs), comprising a blue QD, a green QD, and a red QD; the plurality of QDs being arranged on the transparent substrate;
a band-pass filter film, arranged on the transparent substrate, covering the plurality of QDs, configured to allow a blue light pass by, and reflecting a green light and a red light; and
a polarizing layer, arranged on the band-pass filter film.

2. The color filter substrate of claim 1 further comprising an overcoat, wherein the overcoat is arranged between the polarizing layer and the band-pass filter film and configured to isolate the polarizing layer from the band-pass filter film.

3. The color filter substrate of claim 2, wherein material of the overcoat is epoxy or acrylic.

4. The color filter substrate of claim 1 further comprising a black matrix layer, wherein the black matrix layer is arranged on the transparent substrate and among the plurality of QDs.

5. A color filter substrate, arranged in a liquid crystal display (LCD) panel, comprising:
a transparent substrate;
a plurality of quantum dots (QDs), comprising a blue QD, a green QD, and a red QD; the plurality of QDs arranged on the transparent substrate;
a first overcoat, arranged on the transparent substrate and covering the plurality of QDs;
a band-pass filter film, arranged on the first overcoat and the plurality of QDs, configured to allow a blue light pass by, and reflecting a green light and a red light; and
a polarizing layer, arranged on the band-pass filter film.

6. The color filter substrate of claim 5 further comprising an isolating layer, wherein the isolating layer is arranged between the polarizing layer and the band-pass filter film and configured to isolate the polarizing layer from the band-pass filter film.

7. The color filter substrate of claim 6, wherein a second overcoat is configured to isolate the polarizing layer from the band-pass filter film.

8. The color filter substrate of claim 7, wherein material of the first overcoat and the second overcoat is epoxy or acrylic.

9. The color filter substrate of claim 5, further comprising a black matrix layer, wherein the black matrix layer is arranged on the transparent substrate and among the plurality of QDs.

10. A liquid crystal display (LCD) panel, comprising:
a lower polarizer, configured to polarize light;
an array substrate, comprising a plurality of thin film transistors (TFTs) which are arranged on the array substrate;
a liquid crystal layer; and
a color filter substrate, comprising
a transparent substrate;
a plurality of quantum dots (QDs), comprising a blue QD, a green QD, and a red QD; the plurality of QDs arranged on the transparent substrate;
a first overcoat, arranged on the transparent substrate and covering the plurality of QDs;
a band-pass filter film, arranged on the first overcoat and the plurality of QDs, configured to allow a blue light pass by, and reflecting a green light and a red light; and
a polarizing layer, arranged on the band-pass filter film.

11. The LCD panel of claim 10, wherein the color filter substrate further comprises an isolating layer; the isolating layer is arranged between the polarizing layer and the band-pass filter film and configured to isolate the polarizing layer from the band-pass filter film.

12. The LCD panel of claim 11, wherein a second overcoat is configured to isolate the polarizing layer from the band-pass filter film.

13. The LCD panel of claim 12, wherein material of the first overcoat and the second overcoat is epoxy or acrylic.

14. The LCD panel of claim 10, wherein the color filter substrate further comprises a black matrix layer; the black matrix layer is arranged on the transparent substrate and among the plurality of QDs.
